(19) United States
(12) Patent Application Publication
(10) Pub. No.: US 2023/0401852 A1
(43) Pub. Date: Dec. 14, 2023

(54) Video Scene Change Detection

(71) Applicant: Synamedia Limited, Staines Upon Thames (GB)

(72) Inventors: Mahesh Ramesh Kumar, New York, NY (US); Clint Earl Ricker, Teddington (GB); Robert Pingzi Xu, Duluth, GA (US)

(21) Appl. No.: 17/828,168

(22) Filed: May 31, 2022

(51) Int. Cl. G06V 20/40; G06T 3/40; G06V 10/56

(52) U.S. Cl. CPC G06V 20/49; G06V 20/46; G06V 20/41; G06V 10/56; G06V 20/48; G06T 3/40

(57) ABSTRACT

Techniques for video scene change detection performed at a server including processor(s) and a non-transitory memory are described herein. In some embodiments, the server obtains a media content item including a plurality of frames. The server further partitions the media content item into shots at local maxima of color deltas between the plurality of frames. The server also groups the shots into a list of candidate scenes based on features derived from key frames representing each of the shots. The server additionally generates a list of scenes using the features based on a required number of scenes and a minimum scene duration.

### TECHNICAL FIELD

The present disclosure relates generally to video processing and, more specifically, to the detection of scene changes in videos.

### BACKGROUND

Even with recent advances in machine learning, deep learning, and/or neural networks, previously existing techniques for scene change detection are not practical and cost effective. Traditionally, many academic works use mathematical analysis of visual and/or audio features for scene change detection. However, threshold configurations in such solutions are often impractical in commercial settings, e.g., requiring manual threshold configuration. Further, many previously existing solutions that focus on the accuracy or precision are genre specific, e.g., setting thresholds based on self-learning of prior content in a particular genre. Such solutions are not suitable in broadcast TV, where videos have rapid cuts and many different types, e.g., actions, news, and/or movies mixed with advertisements. As such, previously existing solutions are often impractical and expensive, thus cannot be not widely adopted in commercial settings.

### BRIEF DESCRIPTION OF THE DRAWINGS

So that the present disclosure can be understood by those of ordinary skill in the art, a more detailed description may be had by reference to aspects of some illustrative embodiments, some of which are shown in the accompanying drawings.

FIG. 1 is a block diagram of an exemplary multimedia content delivery system including a scene change detector for detecting scene changes and performing scene cuts, in accordance with some embodiments;

FIG. 2A is a diagram illustrating the exemplary scene change detector performing scene cuts according to dynamic thresholds, in accordance with some embodiments;

FIG. 2B is a diagram illustrating an exemplary iterative adjustment process of the dynamic thresholds for scene cuts, in accordance with some embodiments;

FIGS. 3A and 3B are diagrams illustrating shot detection and frame partition based on local maxima of deltas, in accordance with some embodiments;

FIGS. 4A and 4B are diagrams illustrating grouping and merging shots into candidate scenes based on the dynamic thresholds, in accordance with some embodiments;

FIG. 5 is a diagram illustrating similar shot detection within a time window, in accordance with some embodiments;

FIG. 6 is a diagram illustrating the exemplary scene change detector performing scene cuts based on the dynamic thresholds, in accordance with some embodiments;

FIG. 7 is a flowchart illustrating a scene change detection method, in accordance with some embodiments;

FIG. 8 is another flowchart illustrating a scene change detection method, in accordance with some embodiments; and

FIG. 9 is a block diagram of a computing device for video scene change detection, in accordance with some embodiments.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method, or device. Finally, like reference numerals may be used to denote like features throughout the specification and figures.

### DESCRIPTION OF EXAMPLE EMBODIMENTS

Numerous details are described in order to provide a thorough understanding of the example embodiments shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example embodiments described herein.

### Overviews

Methods, devices, and systems described herein rely on the analysis of frames in video streams for fast and low-cost scene change detection. While prior work focuses on determining whether or not a shot is at the beginning of a new scene, the techniques described herein cut scenes at a given frequency and determine the best places to cut shot boundaries to have a targeted number of scenes. As such, the techniques are practical and scalable with improved accuracy, especially when being used across different genres of videos. The solution described herein opens up a wide variety of use cases such as scene-based content retrieval and navigation.

In accordance with various embodiments, a scene change detection method is performed at a server that includes one or more processors and a non-transitory memory. The method includes obtaining a media content item including a plurality of frames. The method further includes partitioning the media content item into shots at local maxima of color deltas between the plurality of frames. The method also includes grouping the shots into a list of candidate scenes based on features derived from key frames representing each of the shots. The method additionally includes generating a list of scenes using the features based on a required number of scenes and a minimum scene duration.

### EXAMPLE EMBODIMENTS

Methods, devices, and systems for detecting scene changes in videos described herein in accordance with various embodiments are outcome driven as compared to some of the prior rule-based solutions. While previously existing rule-based approaches require tailoring to specific content types for accurate results, the techniques described herein work on any type of video content regardless of the genre(s). In some embodiments, the scene change detection techniques dynamically configure thresholds using a heuristic-based approach based on the targeted scene cut frequency, e.g., the average being x scene(s) per y minute(s), and select the targeted number of scene cuts in a time window after combining shots based on, for instance, object/feature similarity and parallel shot detection. As such, the scene change detection techniques described herein, which are efficient, cost effective, and commercially scalable, allow a broad range of use cases such as scene-based content retrieval and navigation.

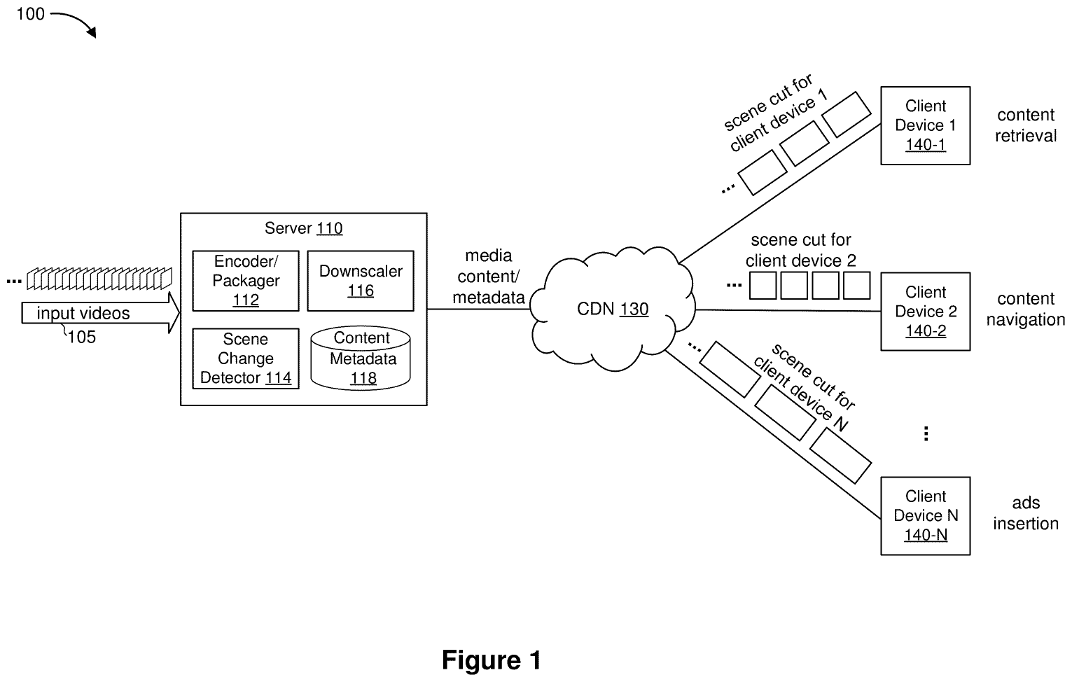

Reference is now made to FIG. 1, which is a block diagram of an exemplary multimedia content processing and delivery system 100 in accordance with some embodiments. In some embodiments, the system 100 includes a server 110 (e.g., a headend), a content delivery network (CDN) 130, and a client device 140. Although a single server 110, a single CDN 130, and a single client device 140 are illustrated in FIG. 1, the system 100 can include one or more servers 110 as well as one or more client devices 140, and can include zero, one, or more CDNs 130. For instance, the CDN(s) 130 can be included in the exemplary system 100 for scalability. As such, the server 110 provides multimedia content to the client device(s) 140, optionally via the CDN(s) 130. For the sake of simplicity, the subject matter will be described hereinafter for the most part with reference to a single server 110, a single client device 140, and a single CDN 130.

In some embodiments, the server 110 includes an encoder packager 112 for encoding multimedia content, e.g., input videos 105, and packaging the encoded content to a suitable format for streaming to a plurality of client devices 140, e.g., client device 1 140-1, client device 2 140-2, . . . , client device N 140-N, etc. The content prepared by the server 110 and received by the client devices 140 can have a variety of encoding and/or packaging formats, including, but are not limited to, advanced video encoding (AVC), versatile video coding (VVC), high efficiency video coding (HEVC), AOMedia video 1 (AV1), VP9, MPEG-2, MPEG-4, etc. In another example, the encoder and packager 112 can package the encoded content according to Dynamic Adaptive Streaming over HTTP (DASH), HTTP Live Streaming (HLS), Smooth Streaming, or HTTP Dynamic Streaming (HDS) format and construct manifest in accordance with HLS or DASH.

In some embodiments, the server 110 also includes a scene change detector 114. In some embodiments, the scene change detector 114 analyzes frames in the input videos 105, generates shots from the frames, and detects whether or not a scene change occurs across the shots in accordance with some embodiments. In some embodiments, as will be described in further detail below, the scene change detector 114 generates the shots and groups the shots according to dynamic thresholds derived from the targeted number of scenes and the minimum scene duration, e.g., x number of scenes in y minutes. As such, the scene cuts produced by the scene change detector 114 can be used for scene-based content search and/or navigation.

In some embodiments, the server 110 additionally includes a downscaler 116 to downscale the input videos 105 to a lower resolution for fast processing. In some embodiments, the downscaler 116 is configured to downscale the input videos 105 as part of the encoding process by the encoder packager 112. As such, the input videos 105 downscaled by the downscaler 116 can be raw (e.g., not encoded) or encoded.

In some embodiments, having processed the input videos 105 and identified scene changes in the videos, the server 110 provides the media content and/or metadata for playing the media content to the client devices 140 via the CDN 130. A respective client device 140 can be a TV, a set-top-box, a computing device, or any other device configured to play the video data. In some embodiments, utilizing the scene change detection, the client devices 140 can perform scene-based content retrieval, content navigation, and/or advertisement insertion, etc.

As will be described in further detail below, the scene change detector 114 performs scene cuts based on dynamic thresholds. As such, as shown in FIG. 1, the same media content item can be cut in to different number of scenes for different purposes. For example, for content retrieval at client device 1 140-1, the targeted scene cut frequency can be different from the targeted scene cut frequency for content navigation at client device 2 140-2, and different from the targeted scene cut frequency for the advertisement insertion at client device N 140-N. Accordingly, when receiving requests for content from different client devices 140, the scene change detector 114 provides different scene cuts proximate the targeted number of scene cuts. As such, the scene change detector 114 performs dynamic scene cuts based on dynamic thresholds.

In some embodiments, the scene change detector 114 performs the scene cuts to meeting the targeted number of scenes requirements specified in content metadata 118. In some embodiments, the content metadata 118 includes channel information for deriving channel mapping information, which specifies whether a particular channel has advertisements (and/or other targeted content) that require performing scene cuts. For example, for certain channels, there is no advertisements. For such channels, using the information from the content metadata 118, the scene change detector 114 skips performing scene cuts and/or the channel mapping indicates zero targeted number of scenes for such channels.

On the other hand, in some embodiments, when a scene detection and/or an advertisement detection feature is enabled at the server 110 for certain channels, the required number of scenes and/or the minimum scene duration for such channels are derived from the content metadata 118. Accordingly, the scene change detector 114 performs scene cuts according to the targeted scene cut frequencies and the scene cut boundaries are communicated to the client devices 140 through a pull mechanism in accordance with some embodiments. For instance, the client devices 140 pull the scene cut and/or advertisement metadata from the server 110, along with the manifest for the media content, and present the scene cut information to users in the form of scene cut markers on the seek bar and/or skip buttons (e.g., in the case of advertisements) in accordance with some embodiments.

It should be noted that one or more components and/or functions of the server 110 and/or the client device 140 may be distributed and/or re-arranged. For example, the scene change detector 114 and/or the downscaler 116 can be on a different and distinct server from the server hosting the encoder packager 112 and/or the content metadata 118. As such, the server 110 and/or the client device 140 in the exemplary content delivery system 100 can include more, less, and/or different elements than shown in FIG. 1. Each of the components in the content delivery system 100 can include appropriate hardware, software, and/or firmware to perform the operations attributed to the element herein. Operation(s) attributed to an element in the content delivery system 100 herein should not be considered binding and in some embodiments, other element(s) in the exemplary system 100 may additionally or alternatively perform such operation(s).

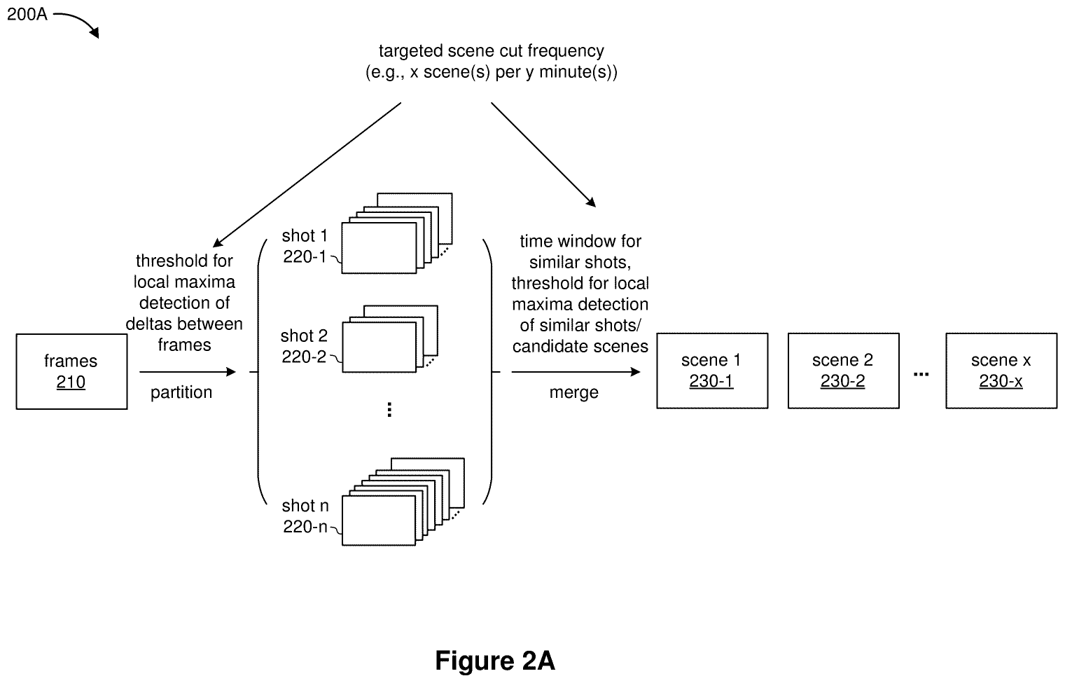

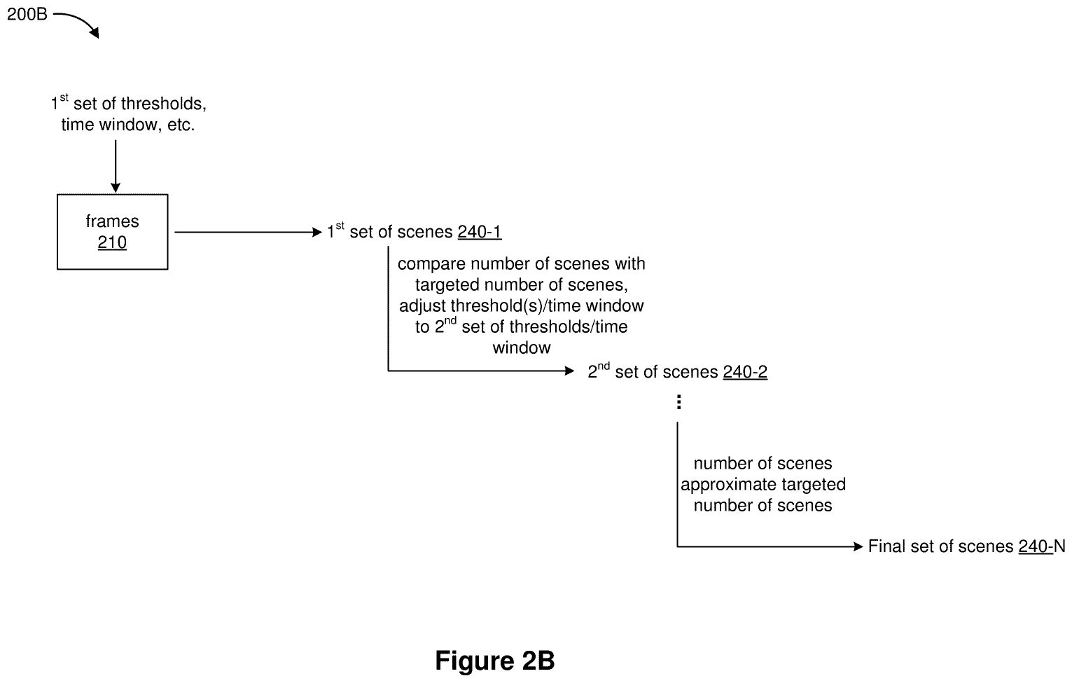

FIG. 2A is a diagram 200 illustrating the scene change detector 114 (FIG. 1) performing scene cuts according to dynamic thresholds in accordance with some embodiments. Video segmentation generally involves the partitioning of a video into its constituent parts, such as scenes, shots, and frames. As used herein, a frame is a single image or picture of a video. As such, the terms “frame”, “image”, and “picture” are used interchangeably. In filmmaking and video production, a shot is a series of frames that runs for an uninterrupted period of time and represents a continuous action in time or space. A shot typically is a group of frames that have consistent visual (including color, texture, and motion) characteristics. Typically, the camera direction and view angle define a shot, e.g., when a camera looks at the same scene from different angles, or at different regions of a scene from the same angle, different (camera) shots are generated. As such, shots are often characterized by the coherence of certain low-level visual features, such as color, texture, and/or motion, etc. A scene comprises a series of consecutive shots grouped together. Scenes are often referred to as story units, story segments, or video paragraphs. For example, the consecutive shots are grouped because they are captured in the same location, at the same time, and/or they share the same thematic content. As such, a frame is the smallest unit; each shot is made up of a plurality of frames; and a scene is made up of several shots.

In FIG. 2A, the scene change detector receives an input video (e.g., the input videos 105 in FIG. 1), obtains frames 210 of the input video, and partitions the frames 210 into shots 220, e.g., shot 1 220-1 including a first series of frames, shot 2 220-2 including a second series of frames, . . . , shot n 220-2 including another series of frames, etc. The scene change detector then merges the shots 220 into a plurality of scenes 230, e.g., scene 1 230-1, scene 230-2, . . . , scene 230-x, etc. When partitioning the frames 210 into the shots 220 and merging the shots 220 to scenes 230, the scene change detector uses a heuristic-based approach and configures dynamic thresholds and a time window based on the targeted scene cut frequency.

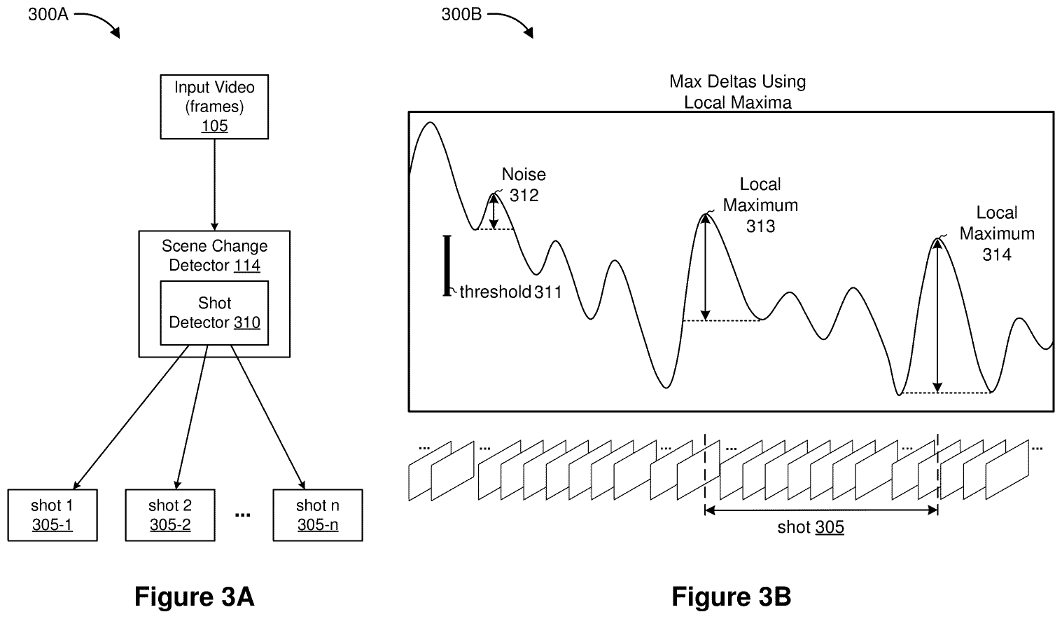

For example, knowing the average number of scene cuts being x scene(s) per y minute(s) for a media content item, e.g., based on the channel mapping derived from content metadata 118 (FIG. 1), the scene change detector configures the threshold for detecting peak deltas between the frames 210. As will be described in further detail below with reference to FIG. 3, boundaries of the shots 220 are at the local maxima that meet a certain threshold. In another example, based on the targeted scene cut frequency, the scene change detector configures the time window for identifying similar shots 220 and/or the threshold for local maxima detection of similar shots 220 in order to generate x number of scene(s) in y minute(s).

FIG. 2B is a diagram 200B illustrating an exemplary iterative threshold adjustment process for scene cuts in accordance with some embodiments. As shown in FIG. 2B, the scene change detector obtains the frames 210 from the input video and follows the process as described above with reference to FIG. 2A to apply a first set of thresholds and/or time windows for generating a first set of scenes 240-1, e.g., using a set of default values. The scene change detector then gradually adjusts the threshold(s) and/or window(s) during each iteration.

As shown in FIG. 2B, the scene change detector compares the number of scenes in the first set of scenes 240-1 with the targeted number of scenes, e.g., the targeted number of scenes, the minimum scene duration, and/or the targeted scene cut frequencies for a channel as specified in the content metadata 118 (FIG. 1). Upon determining that the number of scenes in the first set of scenes 240-1 is not close to the targeted number of scenes, e.g., the difference is not within a threshold, the scene change detector adjusts the first set of thresholds and/or the time windows to a second set of thresholds and/or time windows. In some embodiments, the scene change detector further uses the second set of thresholds and/or time windows to generate a second set of scenes 240-2 from the frames 210. The iterative threshold adjustments continue until the scene change detector generates a final set of scenes 240-N within a time window that has the number of scenes approximate the targeted number of scenes for the media content item, e.g., the difference between the number of scenes in the final set of scenes and the targeted number of scenes is within a threshold. As such, the scene change detector adjusting the threshold(s) and/or time window(s) iteratively, e.g., adjusting with each iteration until the final set of scenes is generated that is the closest to the targeted number of scenes.

As shown in FIGS. 2A and 2B, the heuristic-based approach is outcome driven. Given the tradeoff between latency and accuracy, the method described herein focuses on outcome-based accurate results. Relative to previously existing rule-based approaches that require threshold tailoring according to content types, the method described herein works on any type of video content as the scene change detector looks for the best scene cuts in a particular time window.

FIG. 3A is a diagram 300A illustrating shot detection in accordance with some embodiments. In some embodiments, the scene change detector 114 includes a shot detector 310. In some embodiments, the shot detector 310 receives the input video 105 in the form of a single video file or in segments. As described above with reference to FIG. 1, in some embodiments, the input video 105 received by the shot detector 310 is the output from the downscaler 116 (FIG. 1) so that the video is downscaled to a lower resolution for faster processing by the shot detector 310. In some embodiments, the shot detector 310 uses color comparison techniques to partition frames in the input video 105 into a plurality of shots 305, e.g., shot 1 305-1, shot 2 305-2, . . . , shot n 305-n, etc.

It should be noted that, for any systems discussed herein, there can be additional, fewer, or alternative components performing similar functionality or functionality in alternative orders, or in parallel, within the scope of the various embodiments unless otherwise stated. In particular, color is one attribute for image representation and using color comparison techniques is one embodiment for partitioning frames into shots. Features characterizing the content of the video and extracted from the visual content, audio, text (e.g., speech-to-text translation, closed captioning, subtitles, screenplay or script, etc.), metadata, or other data corresponding to the video can be used in place of or in combination with colors. Visual features utilized for partitioning frames into shots include luminance (e.g., average grayscale luminance or the luminance channel in a color model such as hue-saturation-luminance (HSL)), color histograms, image edges, texture-based features (e.g., Tamura features, simultaneous autoregressive models, orientation features, co-occurrence matrices), features of objects in the video (e.g., faces or color, texture, and/or size of detected objects), transform coefficients (e.g., Discrete Fourier Transform, Discrete Cosine Transform, wavelet), and motion, among others. Further, the size of the region from which features are extracted can also vary. For example, features can be extracted on a pixel-by-pixel basis, at a rectangular block level, according to various shaped regions, or by a whole frame, among other approaches.

FIG. 3B is a diagram 300B illustrating using multi-frame peak delta for shot detection in accordance with some embodiments. In some embodiments, the shot detector 310 compares the colors between the frames from the input video. As explained above with reference to FIG. 3A, other features in addition to or in place of the colors can be used for the comparison. Once features from frames of the video have been extracted, various similarity metrics can be utilized by the shot detector 310 (FIG. 3A) for calculating the deltas between the frames, e.g., cosine similarity, L-norm cosine similarity, Euclidean distance, histogram intersection, chi-squared similarity, earth mover's distance, among others.

In some embodiments, having determined the deltas between the frames, the shot detector 310 then breaks down the input video into shots at local maximum deltas. In some embodiments, the shot detector 310 uses a threshold 311 for determining the local maxima. In some embodiments, the threshold 311 is an initial threshold for filtering out noise 312. In some embodiments, as described above with reference to FIG. 2A, the threshold 311 is derived from the targeted scene cut frequency, e.g., based on the minimum shot duration.

For example, in FIG. 3B, the noise 312 has a peak delta that does not satisfy the threshold 311, e.g., the peak delta value less than the threshold 311. On the other hand, a local maximum 313 and another local maximum 314 each represents a peak delta that satisfies the threshold 311, e.g., the respective peak delta value greater than the threshold 311. As such, the shot detector 310 partitions the frames into shots, e.g., the frames between the local maxima 313 and 314 are partitioned as a respective shot 305.

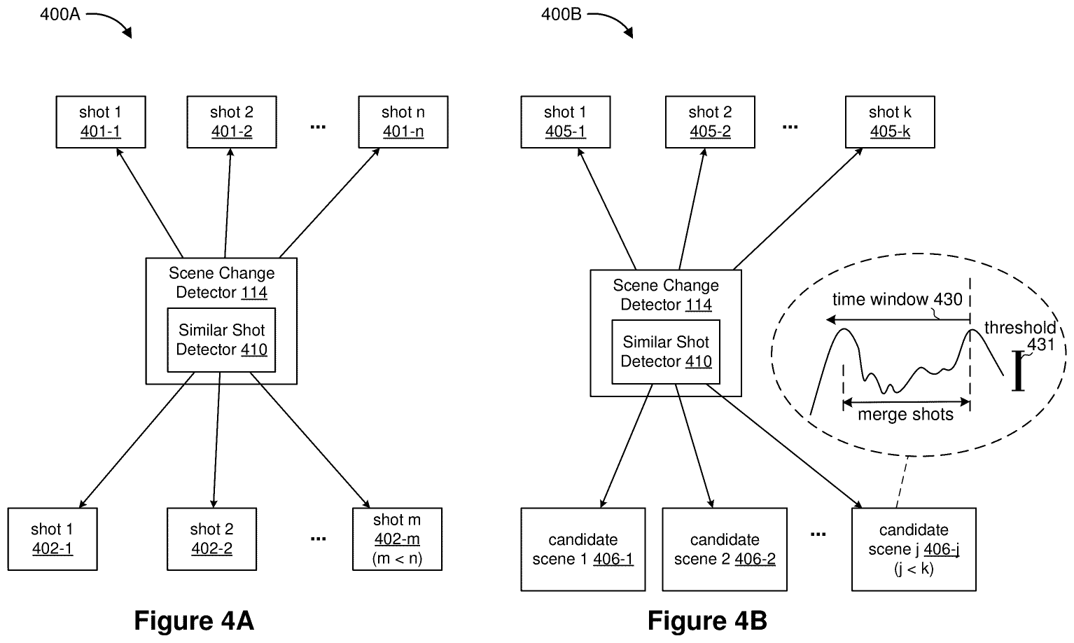

FIGS. 4A and 4B are diagrams 400A and 400B illustrating merging shots in preparation for final scene cut in accordance with some embodiments. In some embodiments, the scene change detector 114 includes a similar shot detector 410 for grouping similar shots. In FIG. 4A, in some embodiments, the similar shot detector 410 processes a first set of shots 401, e.g., shot 1 401-1, shot 2 401-2, . . . , shot n 401-n, etc., to identify similar shots and merge similar ones into a second set of shots 402, e.g., shot 1 402-1, shot 2 402-2, . . . , shot m 402-m, etc., where m<n. In some embodiments, the plurality of shots 401 is the output from the shot detector 310 (FIG. 3A), e.g., after the shot detector 310 using color comparison to compute the deltas between the frames and breaking down the video into shots at local maximum deltas.

To detect similar shots, in some embodiments, the similar shot detector 410 extracts one or more key frames for each shot 401 where the key frame(s) represent the respective shot 401. In some embodiments, the key frame is the i^{th} frame of the shot 410. Alternatively, in some embodiments, the similar shot detector 410 identifies the key frames based on the differences between the frames within the shot. For example, the similar shot detector 410 analyzes the color deltas of the frames in the shot 305 as shown in FIG. 3B and identifies the frame that has the peak delta value at the local maximum 313 as the key frame representing the shot 305. In addition to the colors, features used for determining the differences include edges, shapes, optical flow, motion descriptors (e.g., temporal motion intensity, spatial distribution of motion), MPEG discrete cosine coefficient and motion vectors, among others. Various techniques can be utilized for key frame selection, including sequential comparison-based, global comparison-based, reference frame-based, clustering-based, curve simplification-based, and object-based methods, among others.

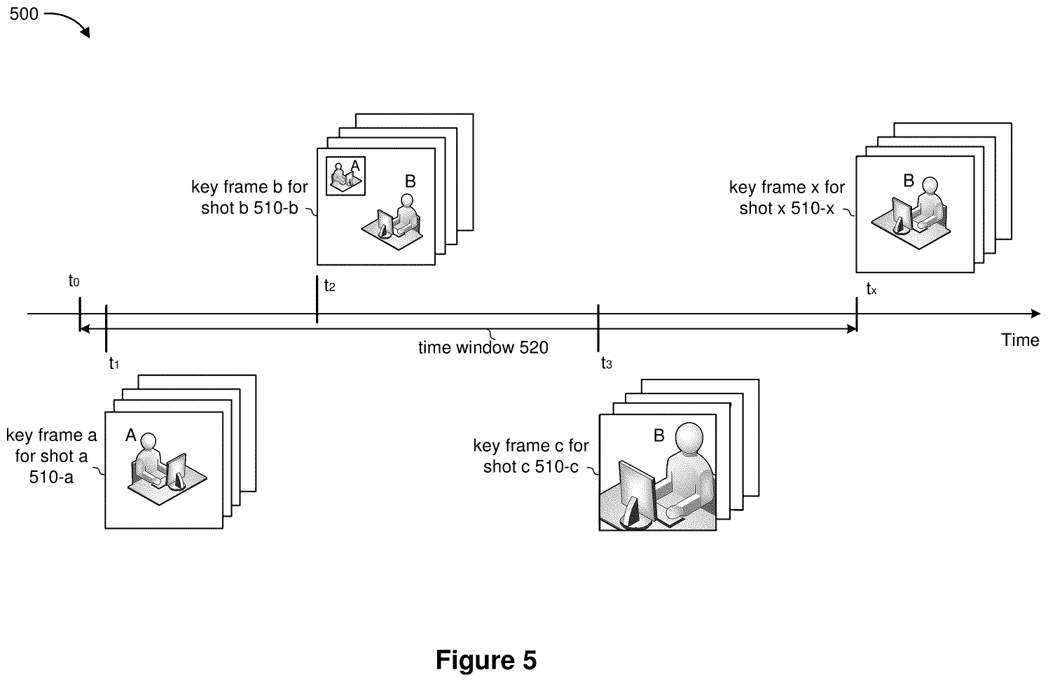

In some embodiments, the similar shot detector 410 identifies similar shots (e.g., parallel shots, panned shots, etc.) among the plurality of shots 401 and groups the similar shots. In some embodiments, as explained above with reference to FIG. 2A, the similar shots are detected by looking back for a predefined time window to check for any similar shots. For example, in FIG. 5, the similar shot detector 410 identifies a key frame representing shot x 510-x at time tₓ, e.g., a key frame with an image of an actor B. The similar shot detector 410 then looks back in a predefined time window 520 for similar shots, e.g., locating similar shots between time tₓ and t₀.

In some embodiments, the similar shot detector 410 identifies parallel shots as similar shots. As explained above, in film making, a scene can include the composition and concatenation of shots that represent sequential or parallel events. Each narrative element in a scene represents one individual event that includes strongly related but not necessarily connected shots. When two or more narrative elements are interleaved with each other, they form parallel shots. Parallel shots can be divided into sub-groups, such as cross-cuttings and shot reverse shots. Cross-cuttings visualize, in general, either (a) time-wise correlated, location-wise disjoined parallel running narrative events, e.g., interactive events happening at the same time but at different location, or (b) time-wise uncorrelated events such as one event and a flash-back, i.e., events happening at different time and at the same or different locations. Shot reverse shots are used to visualize events such as a dialogue between two actors, i.e., a dialog happening at the same time at the same location but captured from two or more camera positions and rendered in an interleaved manner, e.g., showing actor A in key frame a representing shot a 510-a at time t₁ and then showing actor B in key frame c representing shot c 510-c at time t₃ or showing actor B in key frame x representing shot x 510-x at time tₓ, etc. as shown in FIG. 5. In-between the interleaved sequences, distant shots are used, e.g., showing both actor A and actor B in key frame b representing shot b 510-b at time t₂ between time t₁ and time t₃, to introduce spatial relations.

For example, in FIG. 5, the similar shot detector detects a dialog between two people where the camera switches back and forth, e.g., the camera captures an actor A at time t₁ in shot a and the camera captures the conferencing between the actors A and B at time t₂ in shot b, etc. Any dialog detection methods can be used for detecting the dialog as shown in FIG. 5, e.g., using a classification model, based on shot length, shot dynamics, shot similarity, and/or shot repletion, clustering of faces, based on motion intensity and/or audio energy, etc. In some embodiments, after obtaining the similar shots, the similar shot detector processes the similar shot(s) by using the key frame extraction method described above to identify key frame(s) for each of the shot(s), e.g., identifying key frame a representing shot a 510-a and identifying key frame b representing shot b 510-b at time t₂, etc.

Returning to FIG. 4B, in some embodiments, the similar shot detector 410 extracts features from key frames representing shots 405 (e.g., shot 1 405-1, shot 2 405-2, . . . , shot k 405-k, etc.) and uses the features to generate a set of candidate scenes 406 (e.g., candidate scene 1 406-1, candidate scene 2 406-2, . . . , candidate scene j 406-j, etc.), where j<k. In some embodiments, as explained above with reference to FIG. 2A, the similar shots are detected by looking back for a predefined time window and merging shots with a high number of common features in the key frames. In some embodiments, the similar shot detector 410 decides whether to merge shots based on a global threshold. In some embodiments, the similar shot detector 410 decides whether to merge shots based on the local maxima of deltas between key frames representing the shots, where a high local maximum indicates a new candidate scene and vice versa. This would merge shots with changes in camera angle, focal length etc.

For example, in FIG. 5, the similar shot detector locates similar shots within the time window 520. Based on features extracted from key frame c for shot c 510-c, the similar shot detector determines that key frame x representing shot x 510-x and key frame c representing shot c 510-c have a high number of common features, e.g., based on the facial features of the same actor B with different focal length. As such, the delta of the features between key frame x representing shot x 510-x and key frame c representing shot c 510-c is less than the dynamic threshold as described with reference to FIG. 2A. Accordingly, the similar shot detector merges shots c and x. Similarly, in some embodiments, the similar shot detector merges shots a, b, c, and x based on high degree of common among key frames a, b, c, and x.

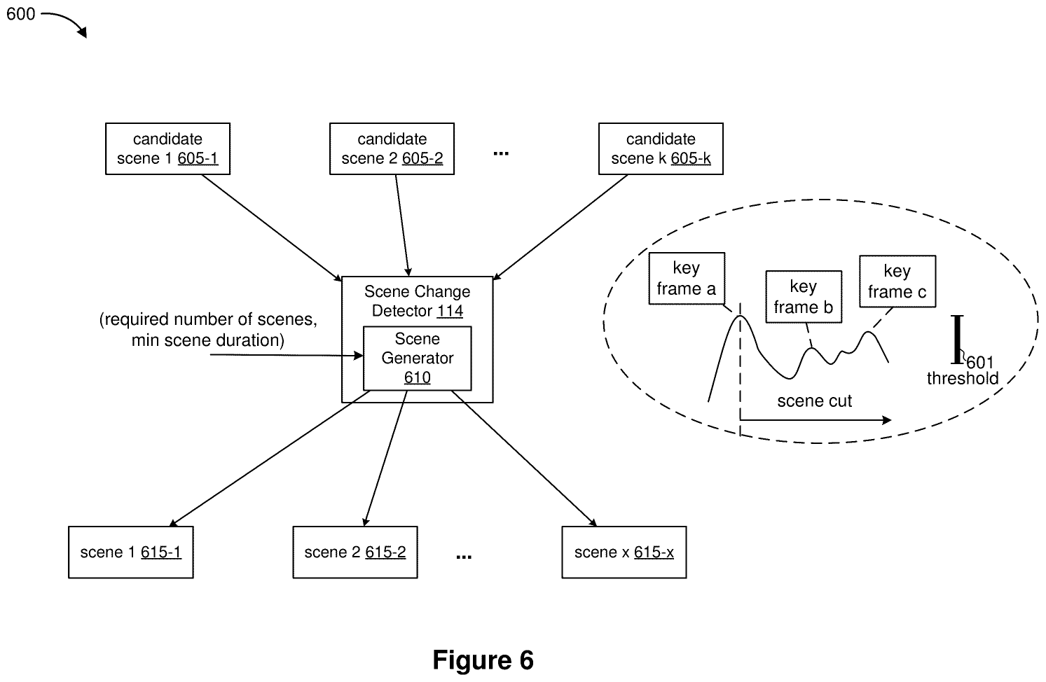

FIG. 6 is a diagram 600 illustrating the scene change detector 114 generating a list of scenes in accordance with some embodiments. In some embodiments, the scene change detector 114 includes a scene generator 610 for processing a list of candidate scenes 605 (e.g., candidate scene 1 605-1, candidate scene 2 605-2, . . . , candidate scene 605-k). In some embodiments, the candidate scenes 605 are outputs from the similar shot detector 410 (FIGS. 4A and 4B). In addition to receiving the list of candidate scenes 605 as input, in some embodiments, the scene generator 610 also receives the required number of scenes and/or the minimum scene duration as inputs, e.g., derived from the targeted scene cut frequency as described above with reference to FIG. 2A. Based on the required number of scenes and the minimum scene duration, the scene generator 610 selects the best ones from the list of candidate scenes 605 to generate the final list of scenes 615, e.g., scene 1 615-1, scene 2 615-2, . . . , scene x 615-x, etc.

In some embodiments, the scene generator 610 uses the color values and/or the features extracted from the key frames belonging to the list of candidate scenes 605 to calculate the deltas among the list of candidate scenes 605. Further, the scene generator 610 selects the list of scenes 615 with the peak delta values satisfying a threshold 601 that is determined dynamically based on the required number of scenes and/or the minimum scene duration. For example, in FIG. 6, the scene generator 610 performs a scene cut at the local maximum of delta corresponding to key frame a, where the local maximum is greater than the threshold 601. In contrast, the scene generator 610 does not perform scene cuts at points corresponding to key frame b and key frame c, where the delta values do not satisfy the threshold 601. As such, the scene generator 610 uses dynamic thresholding for color and/or feature deltas across shot groups to get the target number of scenes.

It should be noted that although the shot detector 310 (FIG. 3A), the similar shot detector 410 (FIGS. 4A and 4B), and the scene generator 610 are illustrated as separate sub-components within the scene change detector 114, each of the modules can be a single sub-system and/or on a separate device, or alternatively, at least some of the components can be combined to be within the same sub-system and/or on the same device.

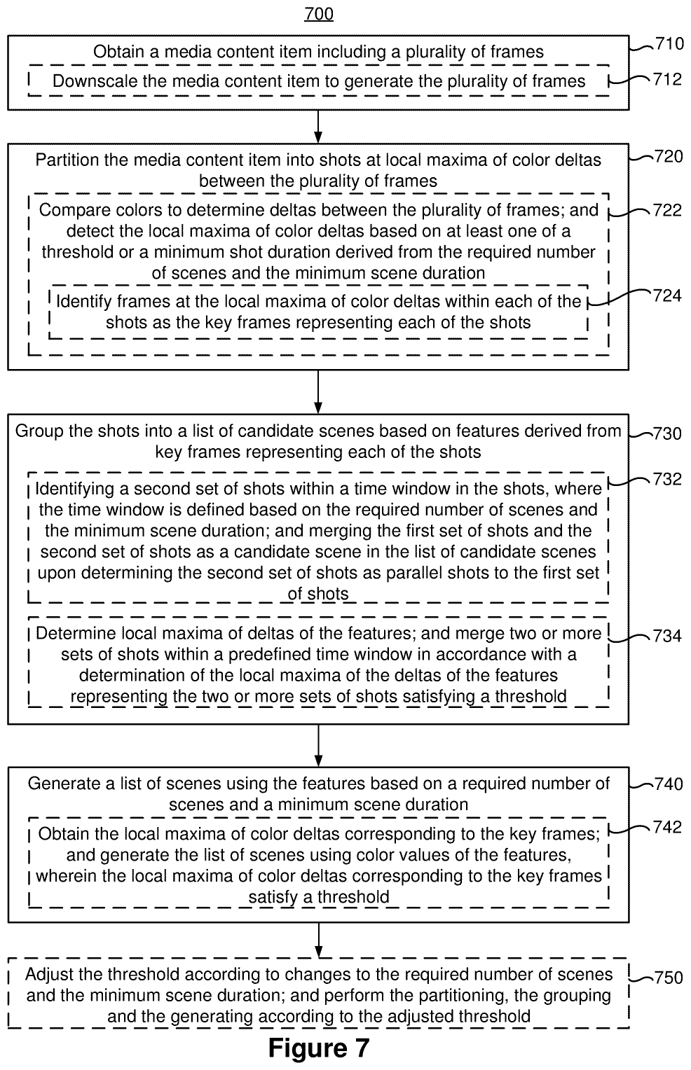

FIG. 7 is a flowchart illustrating a scene change detection method 700 in accordance with some embodiments. In some embodiments, the method 700 is performed at a server, e.g., the server 110 in FIG. 1. In some embodiments, the server includes one or more processors (e.g., one or more processors for the encoder and packager 112, the scene change detector 114, and/or the downscaler 116 in FIG. 1) and a non-transitory memory (e.g., a non-transitory memory for storing the content and/or the metadata). In some embodiments, the method 700 is performed by various modules within the scene change detector 114 (FIG. 1), e.g., by the shot detector 310 (FIG. 3A), the similar shot detector 410 (FIGS. 4A and 4B), and/or the scene generator 610 (FIG. 6).

In FIG. 7, the method 700 begins with the scene change detector obtaining a media content item including a plurality of frames, as represented by block 710. In some embodiments, as represented by block 712, obtaining the media content item including the plurality of frames includes downscaling the media content item to generate the plurality of frames. In other words, the video can be downscaled to a lower resolution for faster processing.

As represented by block 720, the method 700 continues with the scene change detector (e.g., the shot detector 310 in the scene change detector 114, FIG. 3A) partitioning the media content item into shots at local maxima of color deltas between the plurality of frames. As represented by block 722, in some embodiments, partitioning the media content item into the shots at the local maxima of color deltas between the plurality of frames includes: (a) comparing colors to determine deltas between the plurality of frames; and (b) detecting the local maxima of color deltas based on at least one of a threshold or a minimum shot duration derived from the required number of scenes and the minimum scene duration. Further, in such embodiments, as represented by block 724, the method 700 further includes identifying frames at the local maxima of the local maximum of color deltas within each of the shots as the key frames representing each of the shots in accordance with some embodiments.

For example, in FIG. 3B, color comparison techniques are used to compute the deltas between the frames and then break down the video into shots at local maximum deltas that are greater than the threshold 311. As explained with reference to FIG. 2A, in some embodiments, the threshold for detecting the local maxima deltas is derived from the minimum shot duration, e.g., as a function of the targeted scene cut frequency. Further, for example, in FIG. 3, the frame corresponding to the local maximum of color deltas 313 can be extracted as a key frame for the shot 305.

The method 700 continues with the scene change detector grouping the shots into a list of candidate scenes based on features derived from key frames representing each of the shots, as represented by block 730. In some embodiments, as represented by block 732, grouping the shots into the list of candidate scenes based on the features derived from the key frames representing each of the shots includes: (a) identifying a second set of shots within a time window in the shots, where the time window is defined based on the required number of scenes and the minimum scene duration; and (b) merging the first set of shots and the second set of shots as a candidate scene in the list of candidate scenes upon determining the second set of shots as parallel shots to the first set of shots. For example, in FIG. 5, the parallel shots are detected by looking back within the time window 520 to check for any similar shots. Similar key frames indicate that the shots are parallel shots such that a dialog between actor A as shown in key frame a representing shot a 510-a and actor B as shown in key frame x representing shot x 510-x, where the camera switches back and forth between time t₁ and time tₓ. As shown in FIG. 4A, the similar shot detector 410 in the scene change detector 114 merges such similar shots to reduce the number of shots. As explained with reference to FIG. 2A, in some embodiments, the time window for detecting similar shots is derived as a function of the targeted scene cut frequency, e.g., based on the number of scenes, the minimum scene duration, etc.

In some embodiments, as represented by block 734, grouping the shots into the list of candidate scenes based on the features derived from the key frames representing each of the shots includes: (a) determining local maxima of deltas of the features; and (b) merging two or more sets of shots within a predefined time window in accordance with a determination of the local maxima of the deltas of the features representing the two or more sets of shots satisfying a threshold. For example, in FIG. 5, the similar shot detector 410 (FIGS. 4A and 4B) in the scene change detector 114 (FIGS. 4A and 4B) extracts features key frames, checks for feature similarities within the time window 520, and merges shots with a high number of common features. As shown in FIG. 4B, to decide whether to merge a shot or not, the similar shot detector 410 relies on the local maxima satisfying the threshold 431 within the time window 430, where a high local maximum indicates a new shot and vice versa. This would eliminate shots with changes in camera angle, focal length, etc., e.g., merging shot c represented by key frame c 510-c and shot x represented by key frame x 510-x where both show actor B but with different camera angles and/or focal lengths. As explained with reference to FIG. 2A, in some embodiments, the time window for merging similar shots is derived as a function of the targeted scene cut frequency, e.g., based on the number of scenes, the minimum scene duration, etc.

Still referring to FIG. 7, the method 700 continues with the scene change detector generating a list of scenes using the features based on a required number of scenes and a minimum scene duration, as represented by block 740. In some embodiments, as represented by block 742, generating the list of scenes using the features from the list of candidate scenes based on the required number of scenes and the minimum scene duration includes: (a) obtaining the local maxima of color deltas corresponding to the key frames; and (b) generating the list of scenes using color values of the features, wherein the local maxima of color deltas corresponding to the key frames satisfy a threshold. For example, as shown in FIG. 6, the scene generation 610 in the scene change detector 114 uses the color values and/or the features extracted for key frames belonging to the candidate scenes 605 for generating the final list of scenes 615, where the threshold 601 for identifying the local maxima is based on targeted scene cut frequency, e.g., the required number of scenes and/or the minimum scene duration as explained with reference to FIG. 2A.

In some embodiments, as represented by block 750, the method 700 further includes adjusting the threshold according to changes to the required number of scenes and the minimum scene duration, and performing the partitioning, the grouping and the generating according to the adjusted threshold. For example, in FIG. 2B, the scene change detector gradually adjusts the threshold(s) and/or the time window for scene change detection until a final set of scenes is obtained for the media content item that is the closest to the number of required scenes for a minimum scene duration specified in the content metadata. In other words, the scene change detection method described herein is outcome driven, as the scene change detector looks for the best scene cuts in a particular time window for outcome-based accurate results.

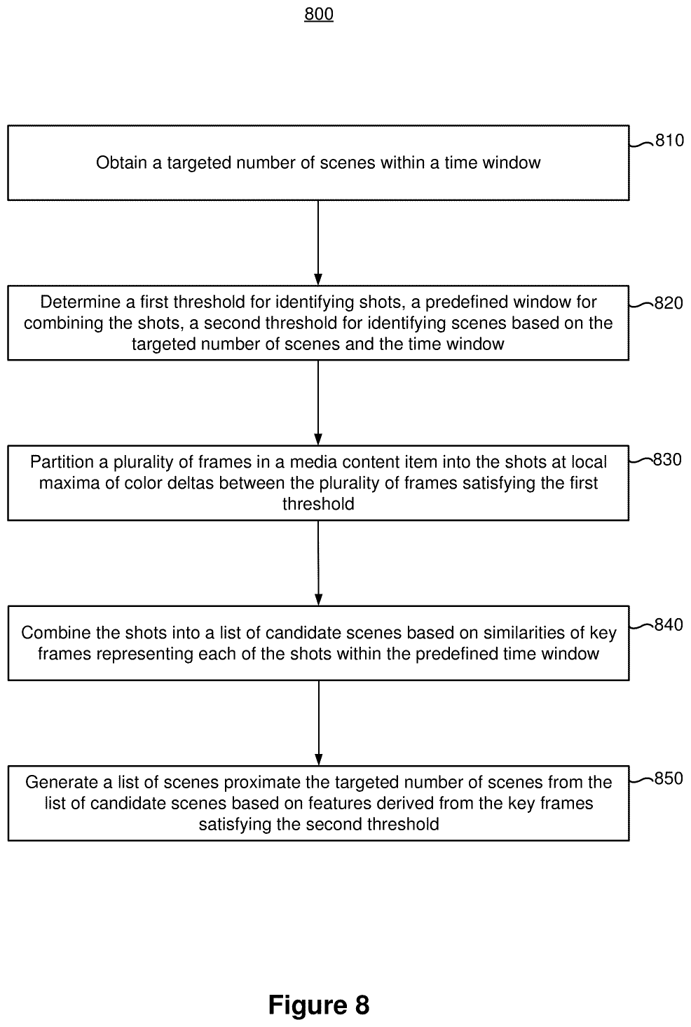

FIG. 8 is a flowchart illustrating a scene change detection method 800 in accordance with some embodiments. In some embodiments, the method 800 is performed at a server, e.g., the server 110 in FIG. 1. In some embodiments, the server includes one or more processors (e.g., one or more processors for the encoder and packager 114, the scene change detector 114, and/or the downscaler 116 in FIG. 1) and a non-transitory memory (e.g., a non-transitory memory for storing the content and/or the metadata). In some embodiments, the method 700 is performed by various modules within the scene change detector 114 (FIG. 1), e.g., by the shot detector 310 (FIG. 3A), the similar shot detector 410 (FIGS. 4A and 4B), and/or the scene generator 610 (FIG. 6).

As represented by block 810, the method 800 begins with the scene change detector obtaining a targeted number of scenes within a time window, e.g., obtaining the targeted scene cut frequency as shown in FIG. 2A. The method 800 continues with the scene change detector determining a first threshold for identifying shots, a predefined time window for combining the shots, and a second threshold for identifying scenes based on the targeted number of scenes and the time window, as represented by block 820, e.g., deriving from the targeted scene cut frequency the threshold 311 for partitioning frames into shots in FIG. 3B, the threshold 431 for merging shots in FIG. 4B, the time window 430 for merging shots in FIG. 4B, the time window 520 for merging shots in FIG. 5, and/or the threshold 601 for generating final scene cuts in FIG. 6.

As represented by block 830, the method 800 continues with the scene change detector partitioning a plurality of frames in a media content item into the shots at local maxima of color deltas between the plurality of frames satisfying the first threshold, e.g., the shot detector 310 partitioning the frames 105 into the shots 305 based on the local maxima of color deltas satisfying the threshold 311, as shown in FIGS. 3A and 3B. As represented by block 840, the method 800 further continues with the scene change detector combining the shots into a list of candidate scenes based on similarities of key frames representing each of the shots within the predefined time window, e.g., the similar shot detector 410 combining shots within the time window based on object and/or feature similarities and/or parallel shot detection as shown in FIGS. 4A-4B and 5. As represented by block 850, the method 800 further continues with the scene change detector generating a list of scenes proximate the targeted number of scenes from the list of candidate scenes based on features derived from the key frames satisfying the second threshold, e.g., the scene generator 610 generating the scenes 615 meeting the targeted scene cut frequency.

Using the scene change detection method 800, the system dynamically configures the thresholds using a heuristic-based approach based on the targeted number of scenes and/or scene cut frequency, e.g., the average being x scenes per y minutes, and selects the best x scene cuts in the y minutes time window after combining shots based on, for instance, object/feature similarity and parallel shot detection. Leaning on the side of practicality, the end results are improved speed and cost effectiveness. As such, the solution is commercially scalable and fits in well with the use cases of scene-based content retrieval and navigation. The scene change detection techniques described herein are outcome driven as compared to some of the prior works that are rule based. While previously existing rule-based approaches require differentiating content types for accurate scene change detection, the techniques described herein work on any type of video content regardless of genre.

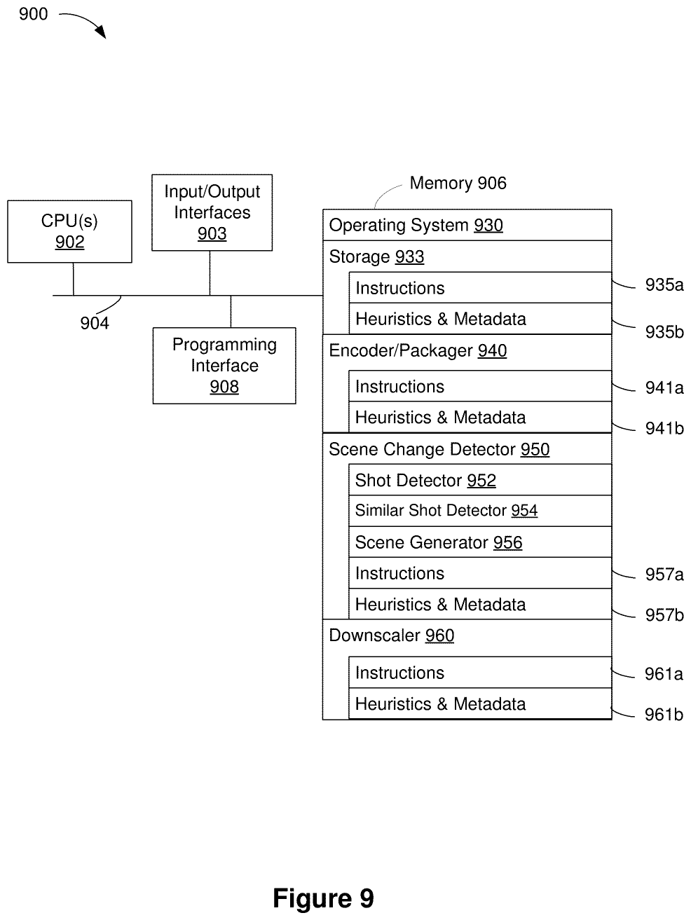

FIG. 9 is a block diagram of a computing device 900 for video scene change detection in accordance with some embodiments. In some embodiments, the computing device 900 performs one or more functions of the server 100 (FIG. 1) and performs one or more of the functionalities described above with respect to the server 100. While certain specific features are illustrated, those skilled in the art will appreciate from the present disclosure that various other features have not been illustrated for the sake of brevity, and so as not to obscure more pertinent aspects of the embodiments disclosed herein. To that end, as a non-limiting example, in some embodiments the computing device 900 includes one or more processing units (CPUs) 902 (e.g., processors), one or more input/output interfaces 903 (e.g., input devices, sensors, a network interface, a display, etc.), a memory 906, a programming interface 908, and one or more communication buses 904 for interconnecting these and various other components.

In some embodiments, the communication buses 904 include circuitry that interconnects and controls communications between system components. The memory 906 includes high-speed random access memory, such as DRAM, SRAM, DDR RAM or other random access solid state memory devices; and, in some embodiments, include non-volatile memory, such as one or more magnetic disk storage devices, optical disk storage devices, flash memory devices, or other non-volatile solid state storage devices. The memory 906 optionally includes one or more storage devices remotely located from the CPU(s) 902. The memory 906 comprises a non-transitory computer readable storage medium. Moreover, in some embodiments, the memory 906 or the non-transitory computer readable storage medium of the memory 906 stores the following programs, modules and data structures, or a subset thereof including an optional operating system 930, a storage module 933, an encoder and/or packager 940, a scene change detector 950, and a downscaler 960. In some embodiments, one or more instructions are included in a combination of logic and non-transitory memory. The operating system 930 includes procedures for handling various basic system services and for performing hardware dependent tasks.

In some embodiments, the storage module 933 stores the video content and the associated metadata for encoding, packaging, and/or scene detection (e.g., shots, similar shots, and/or scene cuts). To that end, the storage module 933 includes a set of instructions 935a and heuristics and metadata 935b.

In some embodiments, the encoder and/or packager 940 (e.g., the encoder and/or packager 112, FIG. 1) is configured to encode and/or package video content. To that end, the encoder and/or packager 940 includes a set of instructions 941a and heuristics and metadata 941b.

In some embodiments, the scene change detector 950 (e.g., the scene change detector 114 in FIGS. 1, 3A-3B, 4A-4B, and 6) is configured to detect scene changes in the encoded and/or packaged video content. In some embodiments, the scene change detector 950 further includes a shot detector 952 (e.g., the shot detector 310 in FIG. 3A) for identifying shots among encoded and/or packaged video frames, a similar shot detector 954 (e.g., the similar shot detector 410 in FIGS. 4A and 4B), and a scene generator 954 (e.g., the scene generator 610 in FIG. 6) for performing scene cuts. To that end, the scene change detector 950 includes a set of instructions 957a and heuristics and metadata 957b.

In some embodiments, the downscaler 960 (e.g., the downscaler 116, FIG. 1) is configured to downscale the video input for scene change detection by the scene change detector 950. To that end, the downscaler 960 includes a set of instructions 961a and heuristics and metadata 961b.

Although the storage module 933, the encoder and/or packager 940, the scene change detector 950, and the downscaler 960 are illustrated as residing on a single computing device 900, it should be understood that in other embodiments, any combination of the storage module 933, the encoder and/or packager 940, the scene change detector 950, and the downscaler 960 can reside in separate computing devices in various embodiments. For example, in some embodiments, each of the storage module 933, the encoder and/or packager 940, the scene change detector 950, and the downscaler 960 resides on a separate computing device.

Moreover, FIG. 9 is intended more as functional description of the various features which are present in a particular implementation as opposed to a structural schematic of the embodiments described herein. As recognized by those of ordinary skill in the art, items shown separately could be combined and some items could be separated. For example, some functional modules shown separately in FIG. 9 could be implemented in a single module and the various functions of single functional blocks could be implemented by one or more functional blocks in various embodiments. The actual number of modules and the division of particular functions and how features are allocated among them will vary from one embodiment to another, and may depend in part on the particular combination of hardware, software and/or firmware chosen for a particular embodiment.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first device could be termed a second device, and, similarly, a second device could be termed a first device, which changing the meaning of the description, so long as all occurrences of the “first device” are renamed consistently and all occurrences of the “second device” are renamed consistently. The first device and the second device are both devices, but they are not the same device.

The terminology used herein is for the purpose of describing particular embodiments only and is not intended to be limiting of the claims. As used in the description of the embodiments and the appended claims, the singular forms “a”, “an”, and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting”, that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

1. A method comprising:
at a server including one or more processors and a non-transitory memory:
obtaining a media content item including a plurality of frames;
partitioning the media content item into shots at local maxima of color deltas between the plurality of frames;
grouping the shots into a list of candidate scenes based on features derived from key frames representing each of the shots; and
generating a list of scenes using the features based on a required number of scenes and a minimum scene duration.

2. The method of claim 1, wherein obtaining the media content item including the plurality of frames includes downscaling the media content item to generate the plurality of frames.

3. The method of claim 1, wherein partitioning the media content item into the shots at the local maxima of color deltas between the plurality of frames includes:
comparing colors to determine deltas between the plurality of frames; and
detecting the local maxima of color deltas based on at least one of a threshold or a minimum shot duration derived from the required number of scenes and the minimum scene duration.

4. The method of claim 3, further comprising:
identifying frames at the local maxima of color deltas within each of the shots as the key frames representing each of the shots.

5. The method of claim 1, wherein grouping the shots into the list of candidate scenes based on the features derived from the key frames representing each of the shots includes:
identifying a second set of shots within a time window in the shots, wherein the time window is defined based on the required number of scenes and the minimum scene duration; and
merging the first set of shots and the second set of shots as a candidate scene in the list of candidate scenes upon determining the second set of shots as parallel shots to the first set of shots.

6. The method of claim 1, wherein grouping the shots into the list of candidate scenes based on the features derived from the key frames representing each of the shots includes:
determining local maxima of deltas of the features; and
merging two or more sets of shots within a predefined time window in accordance with a determination of the local maxima of the deltas of the features representing the two or more sets of shots satisfying a threshold.

7. The method of claim 1, wherein generating the list of scenes using the features from the list of candidate scenes based on the required number of scenes and the minimum scene duration includes:
obtaining the local maxima of color deltas corresponding to the key frames; and
generating the list of scenes using color values of the features, wherein the local maxima of color deltas corresponding to the key frames satisfy a threshold.

8. The method of claim 7, further comprising:
adjusting the threshold according to changes to the required number of scenes and the minimum scene duration; and
performing the partitioning, the grouping and the generating according to the adjusted threshold.

9. A device comprising:
one or more processors; and
the non-transitory memory storing the computer readable instructions, which when executed by the one or more processors, cause the device to:
obtain a media content item including a plurality of frames;
partition the media content item into shots at local maxima of color deltas between the plurality of frames;
group the shots into a list of candidate scenes based on features derived from key frames representing each of the shots; and
generate a list of scenes using the features based on a required number of scenes and a minimum scene duration.

10. The device of claim 9, wherein obtaining the media content item including the plurality of frames includes downscaling the media content item to generate the plurality of frames.

11. The device of claim 9, wherein partitioning the media content item into the shots at the local maxima of color deltas between the plurality of frames includes:
comparing colors to determine deltas between the plurality of frames; and
detecting the local maxima of color deltas based on at least one of a threshold or a minimum shot duration derived from the required number of scenes and the minimum scene duration.

12. The device of claim 11, wherein the computer readable instructions, which when executed by the one or more processors, further cause the device to:
identify frames at the local maxima of color deltas within each of the shots as the key frames representing each of the shots.

13. The device of claim 9, wherein grouping the shots into the list of candidate scenes based on the features derived from the key frames representing each of the shots includes:
identifying a second set of shots within a time window in the shots, wherein the time window is defined based on the required number of scenes and the minimum scene duration; and
merging the first set of shots and the second set of shots as a candidate scene in the list of candidate scenes upon determining the second set of shots as parallel shots to the first set of shots.

14. The device of claim 9, wherein grouping the shots into the list of candidate scenes based on the features derived from the key frames representing each of the shots includes:
determining local maxima of deltas of the features; and
merging two or more sets of shots within a predefined time window in accordance with a determination of the local maxima of the deltas of the features representing the two or more sets of shots satisfying a threshold.

15. The device of claim 9, wherein generating the list of scenes using the features from the list of candidate scenes based on the required number of scenes and the minimum scene duration includes:
obtaining the local maxima of color deltas corresponding to the key frames; and
generating the list of scenes using color values of the features, wherein the local maxima of color deltas corresponding to the key frames satisfy a threshold.

16. The device of claim 15, wherein the computer readable instructions, which when executed by the one or more processors, further cause the device to:
adjust the threshold according to changes to the required number of scenes and the minimum scene duration; and
perform the partitioning, the grouping and the generating according to the adjusted threshold.

17. A non-transitory computer-readable medium that includes computer-readable instructions stored thereon that are executed by one or more processors to perform operations comprising:
obtaining a media content item including a plurality of frames;
partitioning the media content item into shots at local maxima of color deltas between the plurality of frames;
grouping the shots into a list of candidate scenes based on features derived from key frames representing each of the shots; and
generating a list of scenes using the features based on a required number of scenes and a minimum scene duration.

18. The non-transitory computer-readable medium of claim 17, wherein partitioning the media content item into the shots at the local maxima of color deltas between the plurality of frames includes:
comparing colors to determine deltas between the plurality of frames; and
detecting the local maxima of color deltas based on at least one of a threshold or a minimum shot duration derived from the required number of scenes and the minimum scene duration.

19. The non-transitory computer-readable medium of claim 17, wherein grouping the shots into the list of candidate scenes based on the features derived from the key frames representing each of the shots includes:
identifying a second set of shots within a time window in the shots, wherein the time window is defined based on the required number of scenes and the minimum scene duration; and
merging the first set of shots and the second set of shots as a candidate scene in the list of candidate scenes upon determining the second set of shots as parallel shots to the first set of shots.

20. The non-transitory computer-readable medium of claim 17, wherein grouping the shots into the list of candidate scenes based on the features derived from the key frames representing each of the shots includes:
determining local maxima of deltas of the features; and
merging two or more sets of shots within a predefined time window in accordance with a determination of the local maxima of the deltas of the features representing the two or more sets of shots satisfying a threshold.
